(19) United States
(12) Patent Application Publication
(10) Pub. No.: US 2008/0257124 A1
(43) Pub. Date: Oct. 23, 2008

(54) Working table having adjustable fence

(76) Inventor: Ben Yu, Taichung (TW)

Correspondence Address: CHARLES E. BAXLEY, ESQUIRE, 90 JOHN STREET, SUITE 309, NEW YORK, NY, 10038, US

(21) Appl. No.: 11/787,704

(22) Filed: Apr. 17, 2007

(51) Int. Cl. B26D 7/06

(52) U.S. Cl. 83/438

(57) ABSTRACT

A working table includes a front guide rail and a rear guide rail attached to a table member, a lip fence includes a bar having a front portion slidably attached onto the front guide rail and a rear portion adjustable relative to the rear guide rail with an adjusting device for allowing the bar of the lip fence to be adjusted to different height relative to the working table for suitably supporting the lip fence and for preventing the lip fence from scratching or scraping or damaging the rear guide rail or the table member. It is preferable that the adjusting device may be adjusted to different distance or adjusted sidewise relative to the rear guide rail or the table member.

### BACKGROUND OF THE INVENTION

1. Field of the Invention

The present invention relates to a machine tool or a working table, and more particularly to a working table including an adjustable lip fence adjustable to different height and/or adjustable to different distance relative to the working table for suitably supporting the lip fence.

2. Description of the Prior Art

Typical machine tools or working tables comprise one or more primary table members for supporting various machine tools, such as table saws, circular saws, miter saws, etc., and may further include one or more supplementary table members attached to the primary table members for supporting the work pieces.

For example, U.S. Pat. No. 5,116,249 to Shiotani et al. discloses one of the typical table saws comprising a circular saw table member and a miter saw table member, and a supplementary table member attached to the miter saw table member and/or the circular saw table member, and a front guide rail and a rear guide rail attached to the table members for slidably supporting the lip fence.

However, the lip fence is simply and slidably supported on the table members with the guide rails but may not be adjusted to different height and/or adjusted to different distance relative to the working table.

U.S. Pat. No. 5,722,308 to Ceroll et al. discloses a typical machine tool comprising a saw table member, and a pair of telescoping tubular side rails attached to the table member for slidably supporting the lip fence.

However, similarly, the lip fence is simply and slidably supported on the table members with the telescoping tubular side rails but may not be adjusted to different height and/or adjusted to different distance relative to the working table.

U.S. Pat. No. 5,797,307 to Horton discloses another typical machine tool also comprising a stationary work platform, and a pair of elongate parallel cylindrical rails attached to the table member for slidably supporting the lip fence.

However, similarly, the lip fence is simply and slidably supported on the table members with the elongate parallel cylindrical rails but may not be adjusted to different height and/or adjusted to different distance relative to the working table.

U.S. Pat. No. 6,439,280 to Wang discloses a further typical machine tool also comprising a stationary working table device, one or more supplementary table members attached to the primary table members for supporting the work pieces, and a pair of parallel guide rails attached to the table member for slidably supporting the lip fence.

However, similarly, the lip fence is simply and slidably supported on the table members with the parallel guide rails but may not be adjusted to different height and/or adjusted to different distance relative to the working table.

The present invention has arisen to mitigate and/or obviate the afore-described disadvantages of the conventional machine tools or working tables.

### SUMMARY OF THE INVENTION

The primary objective of the present invention is to provide a working table including an adjustable lip fence adjustable to different height and/or adjustable to different distance relative to the working table for suitably supporting the lip fence.

In accordance with one aspect of the invention, there is provided a working table comprising a table member, a front guide rail and a rear guide rail attached to the table member, a lip fence including a bar having a front portion slidably attached onto the front guide rail, the bar including a rear portion, and an adjusting device for adjusting the rear portion of the bar relative to the rear guide rail.

The adjusting device includes a shank attached to the rear portion of the bar, and a threaded stem threaded and engaged with the shank for adjusting the rear portion of the bar to different height relative to the rear guide rail in order to suitably support the lip fence. The shank includes an inner thread formed therein for threading and engaging with the threaded stem.

The threaded stem includes a pad attached to bottom for slidably engaging with the rear guide rail. The rear guide rail includes a vertical flap secured to the table member, and a horizontal flap extended from the vertical flap, and the pad is slidably engaged with the horizontal flap of the rear guide rail.

The bar includes a channel formed in the rear portion of the bar, and the shank includes a threaded member extended outwardly therefrom and engaged through the channel of the bar for guiding the shank to slide along the channel of the bar and for adjusting the shank relative to the rear portion of the bar and the rear guide rail.

The bar includes an anchor having a screw hole formed therein for threading and engaging with the threaded member of the shank and for securing the shank to the rear portion of the bar. The anchor includes a protrusion extended therefrom and slidably engaged with the channel of the bar for guiding the shank and the anchor to slide along the channel of the bar.

The shank includes a retaining ring attached to the threaded member for engaging with the anchor and for preventing the anchor from being disengaged from the threaded member of the shank. The threaded member includes an outer diameter smaller than that of the shank for forming a peripheral shoulder between the threaded member and the shank and for engaging with the bar.

The threaded stem includes a lock nut attached and engaged with the threaded stem for engaging with the shank and for securing the threaded stem to the shank. The bar includes a securing device attached to the front portion of the bar for selectively securing the bar of the lip fence to the front guide rail.

The lip fence includes at least one auxiliary panel selectively attached to the bar. The bar includes at least one key hole formed therein, and the auxiliary panel includes at least one key hole formed therein and aligned with the key hole of the bar for receiving a fastener which selectively and detachably secures the auxiliary panel to the bar.

The bar includes at least one opening formed therein for tool receiving purposes. The bar includes at least one plug for selectively blocking the opening of the bar.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a machine tool or working table including an adjustable lip fence in accordance with the present invention;

FIG. 2 is a perspective view illustrating the adjustable lip fence of the machine tool or working table;

FIG. 3 is a partial exploded view of the adjustable lip fence of the machine tool or working table;

FIG. 4 is a partial cross sectional view of the machine tool or working table taken along lines 4-4 of FIG. 1;

FIGS. 5, 6, 7 are partial cross sectional views similar to FIG. 4, illustrating the operation of the working table;

FIG. 8 is a partial exploded view similar to FIG. 3, illustrating the other arrangement of the working table;

FIG. 9 is a partial cross sectional view of the machine tool or working table as shown in FIG. 8; and

FIG. 10 is a perspective view similar to FIG. 2, illustrating the further arrangement of the working table.

### DETAILED DESCRIPTION OF THE PREFERRED EMBODIMENT

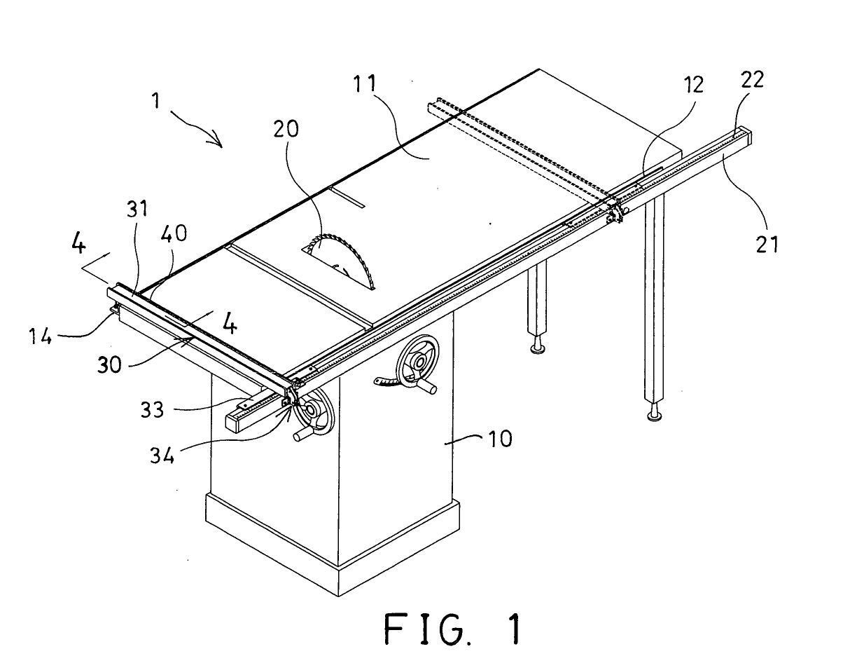

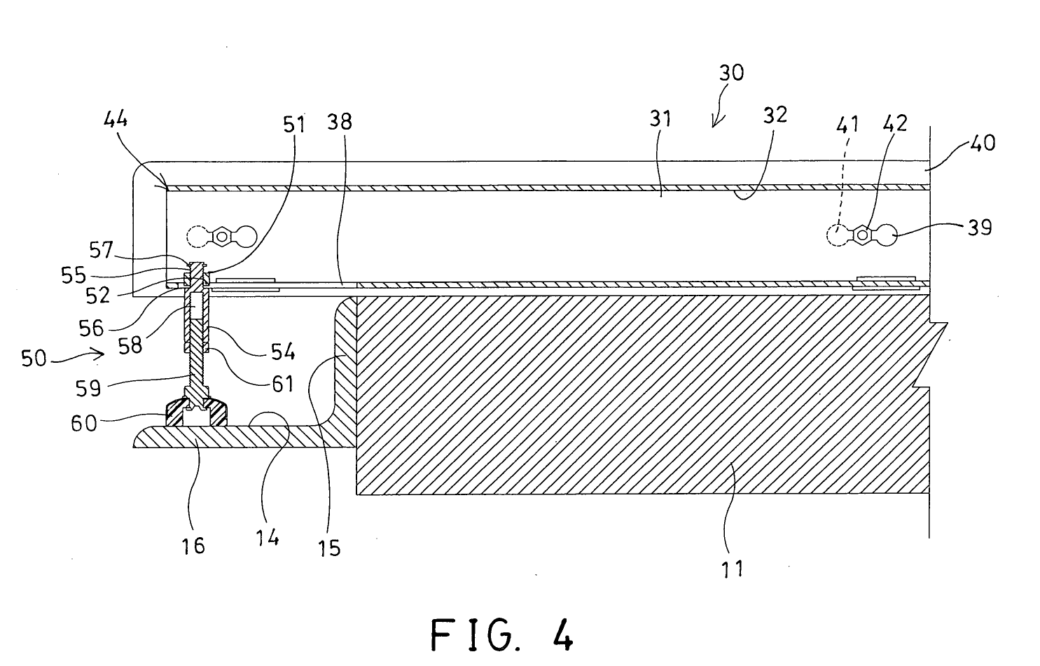

Referring to the drawings, and initially to FIG. 1, a machine tool or working table 1 in accordance with the present invention comprises a stationary base 10, one or more work platforms or table members 11 disposed on or attached to the stationary base 10 for supporting various machines or tool members 20, such as table saws or miter saws or circular saws 20, etc., and/or for supporting the work pieces, and a front guide rail 12 and a rear guide rail 14 attached to the table member 11 for slidably supporting a fence body or lip fence 30. It is preferable that an elongate rule or ruler 21 solidly attached to the front guide rail 12 and having a scale or graduation 22 formed or provided thereon. As shown in FIGS. 4-7, the rear guide rail 14 includes a vertical flap 15 secured to the rear portion of the table member 11, and a horizontal flap 16 extended rearwardly from the vertical flap 15 of the rear guide rail 14 and/or the table member 11.

The lip fence 30 includes a fence body or elongate bar 31 preferably having a hollow structure or having a bore 32 formed therein, and arranged parallel or perpendicular to the tool members 20 and arranged perpendicular to the guide rails 12, 14, an L-shaped angle or guide 33 (FIGS. 1-3) attached or secured to one end of the bar 31 and arranged perpendicular to the bar 31 and slidably supported on or engaged onto the front guide rail 12 for guiding the bar 31 of the lip fence 30 to smoothly move along the front guide rail 12 and to move along or relative to the ruler 21. A fastening or securing device 34, such as a quick release securing device 34 is attached to the front portion 35 of the bar 31 of the lip fence 30 for selectively securing the bar 31 of the lip fence 30 to the front guide rail 12 and/or the ruler 21 or for selectively releasing the lip fence 30 from the front guide rail 12 and/or the ruler 21, the front portion 35 of the bar 31 may also be directly and slidably engaged onto the front guide rail 12.

The lip fence 30 may further include one or more openings 36 formed in the bottom portion of the bar 31 and communicating with the bore 32 of the lip fence 30 for allowing the driving tools, such as wrenches (not shown) to be selectively engaged into the bore 32 of the lip fence 30, and one or more plugs 37 selectively engaged into the openings 36 of the bar 31 or the lip fence 30 for blocking or closing the openings 36 of the bar 31 or the lip fence 30. The lip fence 30 further includes an oblong hole or elongate channel 38 formed in the bottom portion of the bar 31 and also communicating with the bore 32 of the lip fence 30, and one or more key holes 39 formed in each of the side portions of the bar 31, and one or more (such as two) auxiliary panels 40 selectively, but not necessarily attached or secured to the side portions of the bar 31 for engaging with different work pieces, or for increasing the contacting areas with the work pieces.

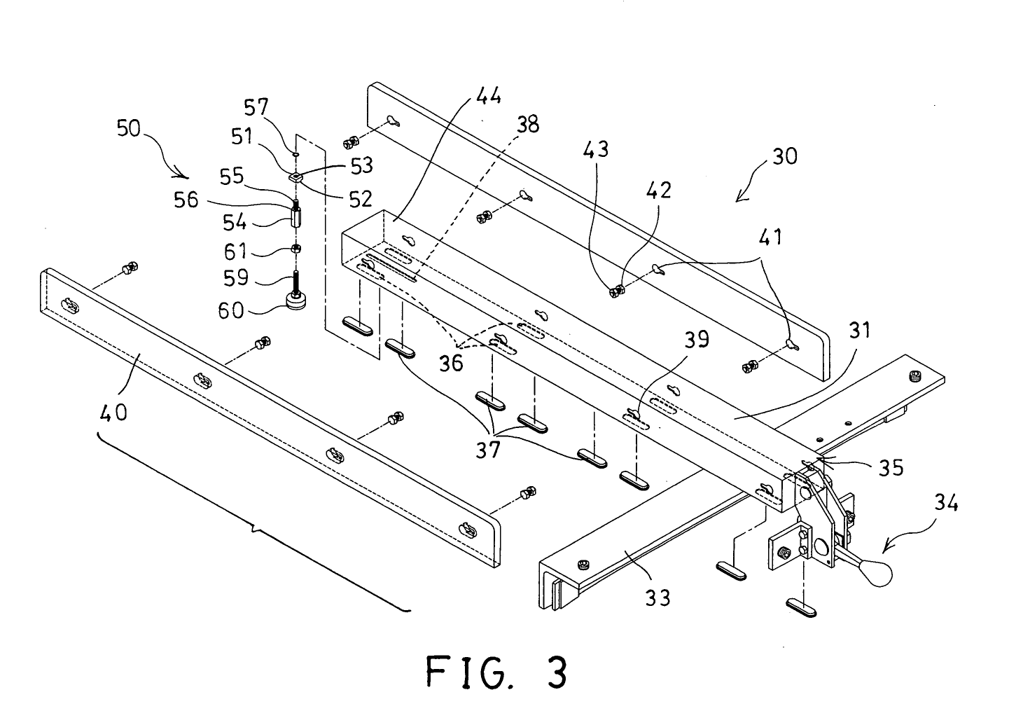

For example, the auxiliary panels 40 each may also include one or more key holes 41 formed therein and aligned with the key holes 39 of the bar 31, and preferably disposed or arranged opposite to the key holes 39 of the bar 31 for receiving fasteners 42, such as bolts 42 and nuts 43 (FIG. 3) which may selectively and detachably attach or secure the auxiliary panels 40 to the side portions of the bar 31. In fastening or locking or releasing the fasteners 42, the driving tools, such as wrenches (not shown) may be selectively engaged through the openings 36 of the bar 31 or the lip fence 30 and engaged into the bore 32 of the lip fence 30 for engaging with the fasteners 42 and for allowing the fasteners 42 to be suitably anchored or positioned or to be rotated or driven by the driving tools. When the driving tools are not required to be engaged into the bore 32 of the lip fence 30, the openings 36 of the bar 31 or the lip fence 30 may be selectively blocked or closed by the plugs 37.

An adjusting means or device 50 may further be provided and attached or secured to the rear portion 44 of the bar 31 for selectively adjusting the rear portion 44 of the bar 31 to different height and/or to different distance or sidewise relative to the rear guide rail 14 or the rear portion of the table member 11 and for suitably supporting the lip fence 30. The adjusting means or device 50 includes an anchor 51 having a protrusion 52 extended outwardly or downwardly therefrom for slidably engaging with or into the elongate channel 38 of the bar 31 and for guiding the anchor 51 to slide along the elongate channel 38 of the bar 31, the anchor 51 includes a screw hole 53 formed therein, a shank 54 includes a bolt or fastener or threaded member 55 extended outwardly therefrom and engaged through the elongate channel 38 of the bar 31 and threaded or engaged with the screw hole 53 of the anchor 51 for selectively and adjustably securing the shank 54 and the anchor 51 to the bar 31.

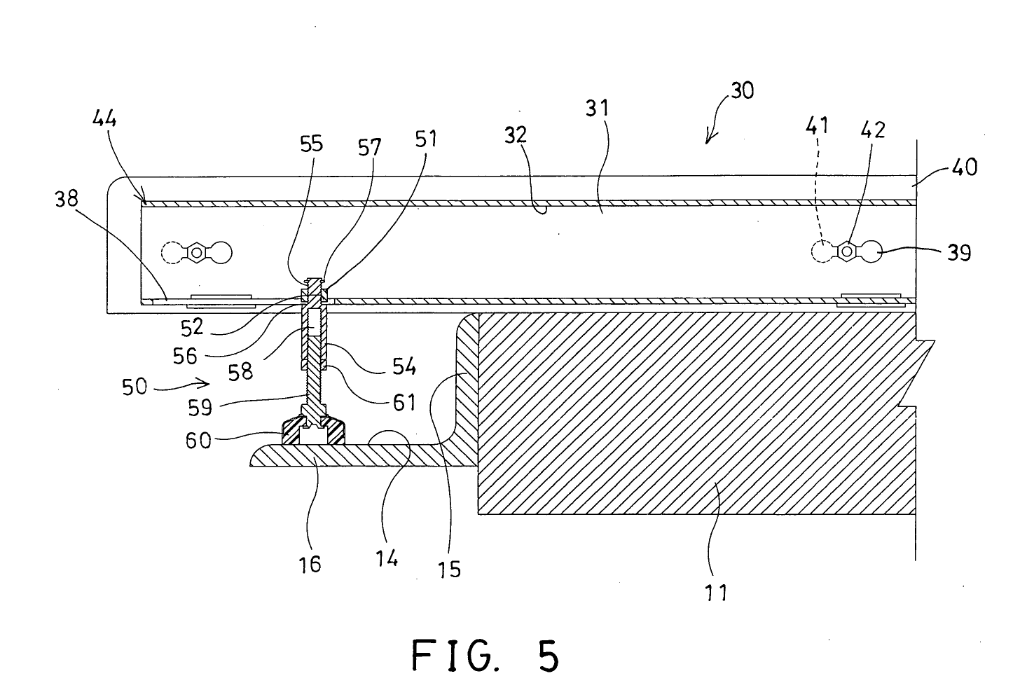

In operation, as shown in FIGS. 4 and 5, the shank 54 and the anchor 51 may be moved or slid or adjusted along the elongate channel 38 of the bar 31 and may thus be moved or adjusted to different distance relative to the rear guide rail 14 or the rear portion of the table member 11 in order to suitably support the lip fence 30, before the threaded member 55 of the shank 54 is solidly threaded or engaged with the screw hole 53 of the anchor 51. The threaded member 55 includes an outer diameter smaller than that of the shank 54 for forming a peripheral shoulder 56 between the threaded member 55 and the shank 54 and for allowing the shank 54 to engage with the bottom portion of the bar 31 and thus for further anchoring the shank 54 to the bar 31. A clamping ring or retaining ring 57 may further be provided and attached or secured to the free end portion of the threaded member 55 for engaging with the anchor 51 and for preventing the anchor 51 from being disengaged from the threaded member 55 of the shank 54.

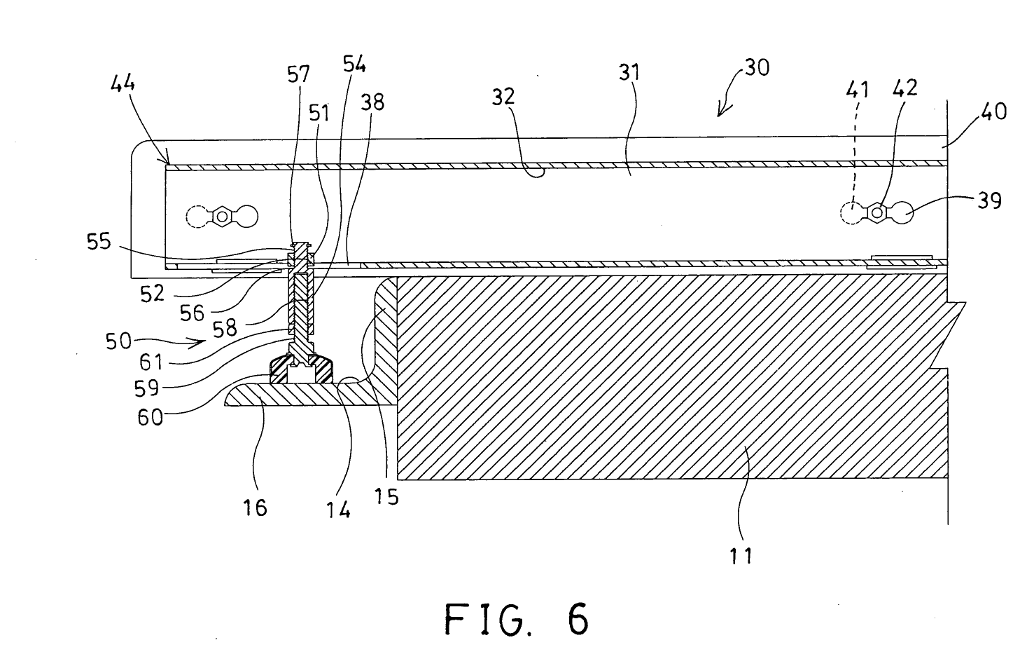

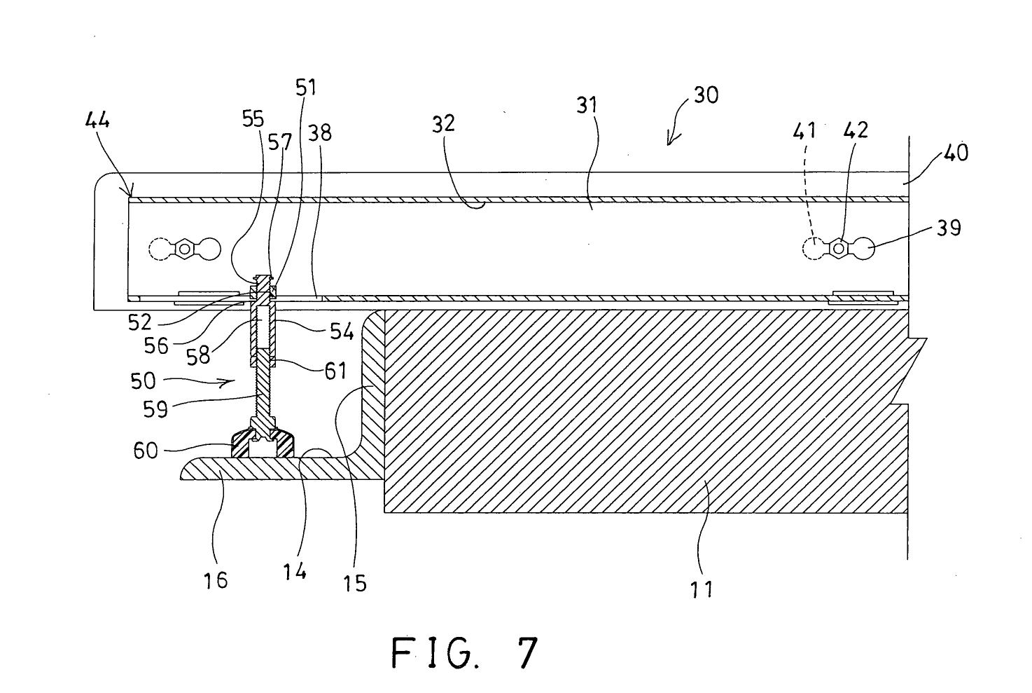

The shank 54 further includes a screw hole or inner thread 58 formed therein, such as formed in the lower or bottom portion thereof for adjustably threading or engaging with a threaded stem 59 and for selectively adjusting the rear portion 44 of the bar 31 to different height relative to the rear guide rail 14 or the rear portion of the table member 11 in order to further suitably support the lip fence 30. For example, the threaded stem 59 may be rotated relative to the rear guide rail 14 or the bar 31 by the users in order to move or adjust the shank 54 and the anchor 51 and the rear portion 44 of the bar 31 to different height relative to the rear guide rail 14 or the rear portion of the table member 11 (FIGS. 6, 7). The rear portion 44 of the bar 31 may thus be adjusted to different height relative to the rear guide rail 14 or the rear portion of the table member 11, and the adjusting means or device 50 may be adjusted to different distance relative to the rear guide rail 14 or the rear portion of the table member 11.

A pad 60 is preferably made of soft or rubber or plastic or other synthetic materials and is attached or secured to the bottom portion of the threaded stem 59 for slidably and safely or softly engaging with the horizontal flap 16 of the rear guide rail 14 and for preventing the threaded stem 59 from scratching or scraping or damaging the horizontal flap 16 of the rear guide rail 14. A lock nut 61 may further be provided and attached or secured to the threaded stem 59 for selectively engaging with the shank 54 and for securing the threaded stem 59 to the shank 54 when or after the threaded stem 59 has been rotated relative to the shank 54 to support the rear portion 44 of the bar 31 at the required or predetermined height relative to the rear guide rail 14 or the rear portion of the table member 11.

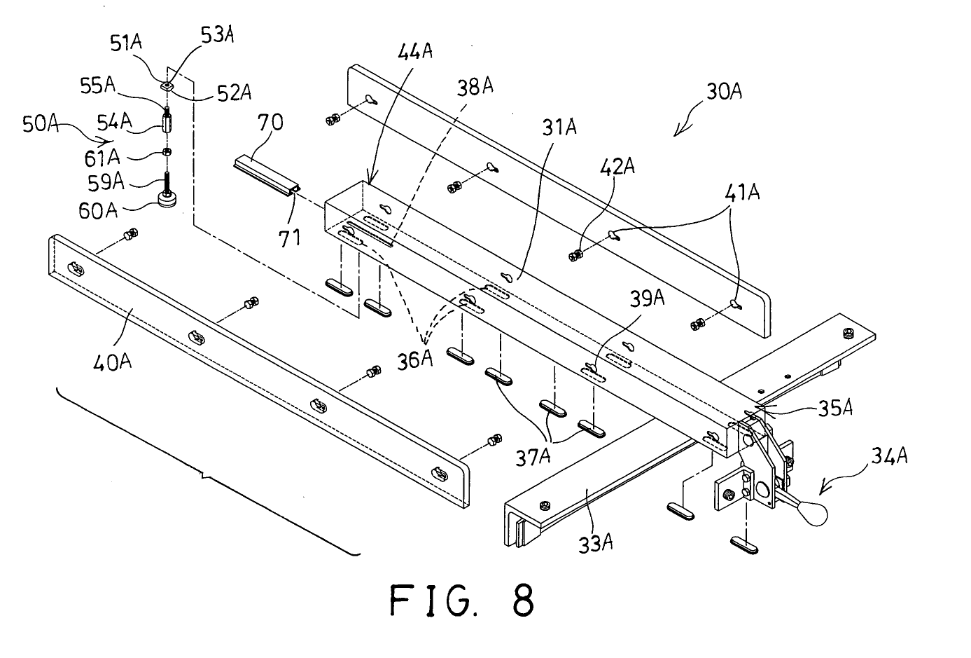

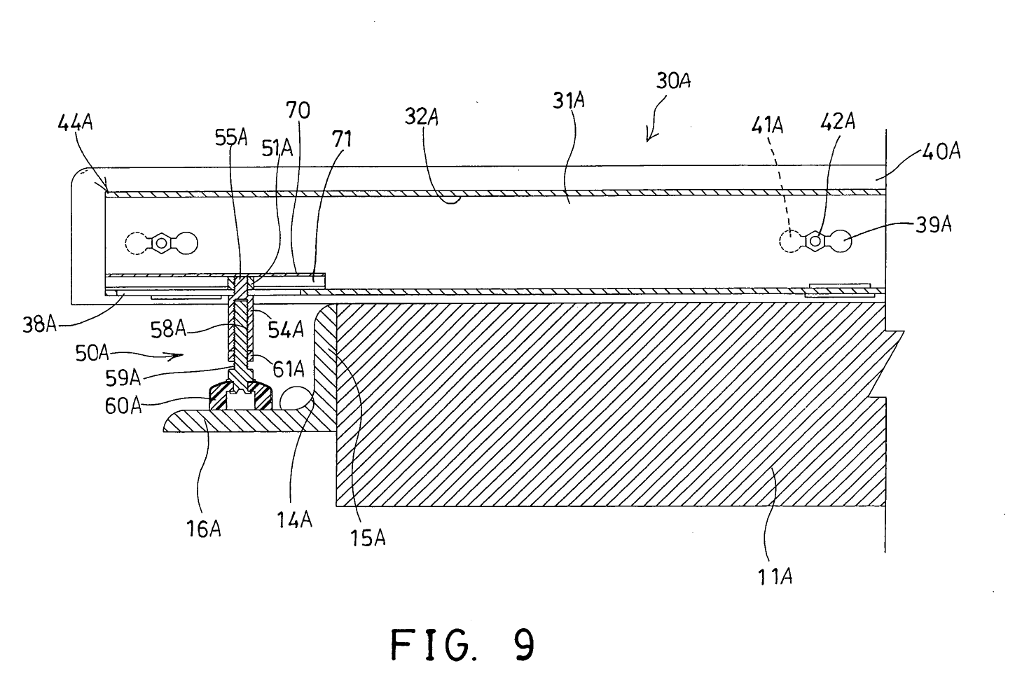

Alternatively, as shown in FIGS. 8 and 9, the table member 11A also includes a rear guide rail 14A having a vertical flap 1 SA secured or attached to the table member 11A, and a horizontal flap 16A extended rearwardly from the vertical flap 15A of the rear guide rail 14A and/or the table member 11A, a lip fence 30A includes an elongate bar 31A having a bore 32A formed therein, an L-shaped angle or guide 33A is attached or secured to one end of the bar 31A, a securing device 34A is attached to the front portion 35A of the bar 31A for selectively securing the bar 31A of the lip fence 30A, the lip fence 30A includes one or more openings 36A formed in the bottom and communicating with the bore 32A of the lip fence 30A, and one or more plugs 37A may selectively block or close the openings 36A of the bar 31A or the lip fence 30A.

The lip fence 30A also includes a channel 38A formed in the bar 31A and communicating with the bore 32A of the lip fence 30A, and one or more key holes 39A formed in each of the side portions of the bar 31A, and one or more (such as two) auxiliary panels 40A are selectively attached or secured to the side portions of the bar 31A and each include one or more key holes 41A aligned with the key holes 39A of the bar 31A for receiving fasteners 42A which may selectively and detachably attach or secure the auxiliary panels 40A to the side portions of the bar 31A. An adjusting means or device 50A includes an anchor 51A having a protrusion 52A slidably engaged with the elongate channel 38A of the bar 31A and having a screw hole 53A for threading with a threaded member 55A of the shank 54A, the shank 54A includes an inner thread 58A for threading or engaging with a threaded stem 59A for adjusting the shank 54A and the anchor 51A and the other end or rear portion 44A of the bar 31A to different height relative to the rear guide rail 14A or the rear portion of the table member 11A.

A pad 60A is preferably made of soft or rubber or plastic or other synthetic materials and is attached or secured to the bottom portion of the threaded stem 59A for slidably and safely or softly engaging with the horizontal flap 16A of the rear guide rail 14A and for preventing the threaded stem 59A from scratching or scraping or damaging the horizontal flap 16A of the rear guide rail 14A. A lock nut 61A may further be attached or secured to the threaded stem 59A for selectively engaging with the shank 54A and for securing the threaded stem 59A to the shank 54A when or after the threaded stem 59A has been rotated relative to the shank 54A to support the rear portion 44A of the bar 31A at the required or predetermined height relative to the rear guide rail 14A or the rear portion of the table member 11A. A frame 70 may further be provided and attached or disposed in the bore 32A of the lip fence 30A and secured to the bar 31A of the lip fence 30A, and includes a pathway 71 formed therein for slidably receiving the anchor 51A and for positioning the anchor 51A to the bar 31A of the lip fence 30A.

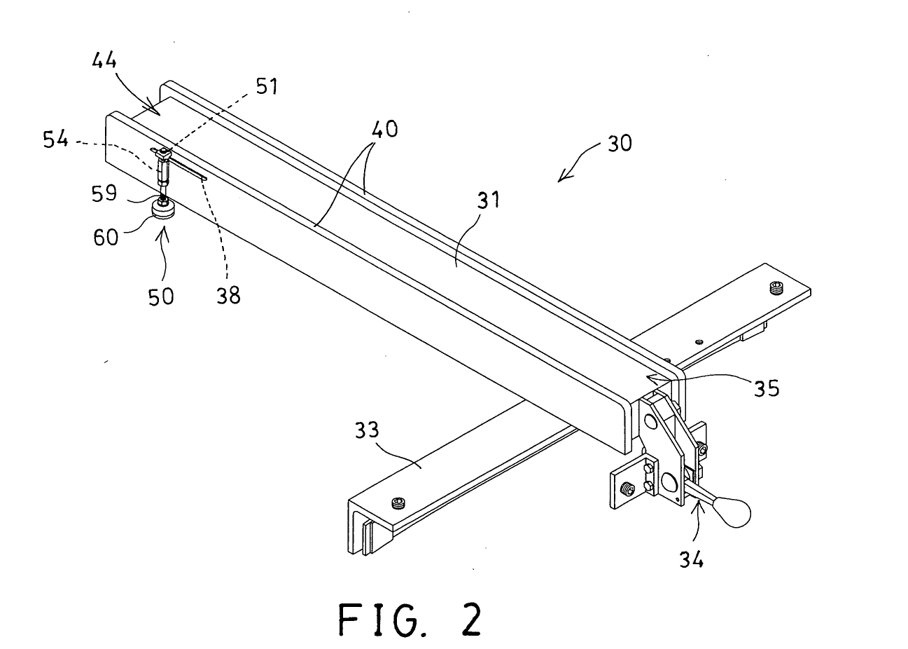

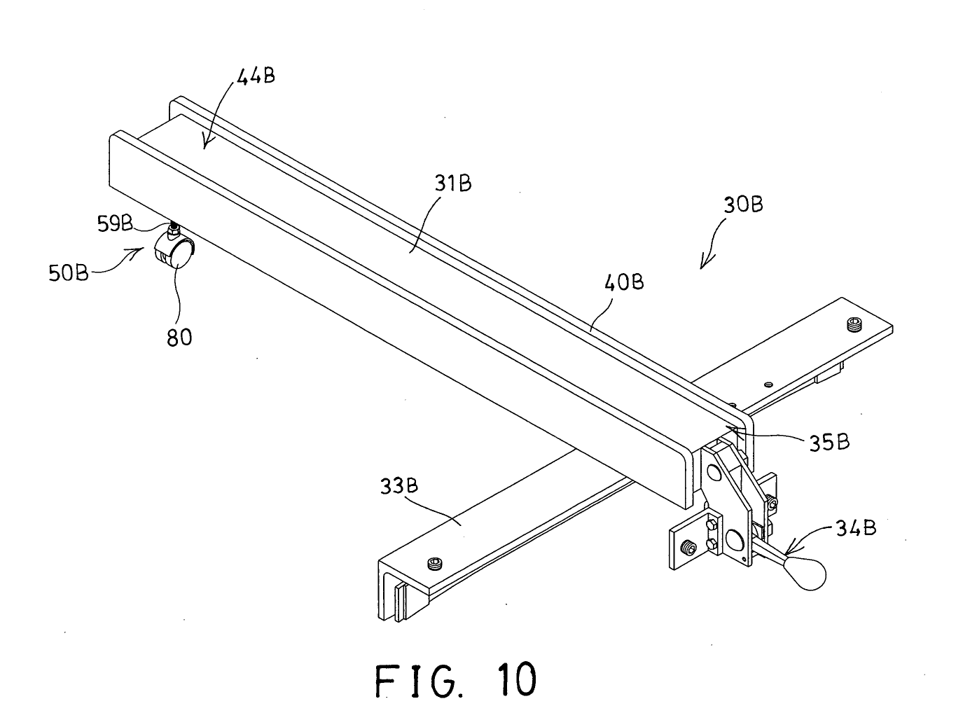

Further alternatively, as shown in FIG. 10, the lip fence 30B also includes an elongate bar 31B having an L-shaped angle or guide 33B attached or secured to one end of the bar 31B, a securing device 34B is attached to the front portion 35B of the bar 31B, one or more (such as two) auxiliary panels 40B mat be selectively attached or secured to the side portions of the bar 31B, and the adjusting means or device 50B also includes a threaded stem 59B for adjusting the rear portion 44B of the bar 31B to different height relative to the rear guide rail or the rear portion of the table member. Instead of the pad 60 (FIGS. 2-7), 60A (FIGS. 8, 9), a roller or wheel 80 may further be provided and attached or secured to the bottom portion of the threaded stem 59B for slidably and safely engaging with the horizontal flap of the rear guide rail.

Accordingly, the working table in accordance with the present invention includes an adjustable lip fence adjustable to different height and/or adjustable to different distance relative to the working table for suitably supporting the lip fence.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A working table comprising:
a table member,
a front guide rail and a rear guide rail attached to said table member,
a lip fence including a bar having a front portion slidably attached onto said front guide rail, said bar including a rear portion, and
means for adjusting said rear portion of said bar relative to said rear guide rail.

2. The working table as claimed in claim 1, wherein said adjusting means includes a shank attached to said rear portion of said bar, and a threaded stem threaded and engaged with said shank for adjusting said rear portion of said bar to different height relative to said rear guide rail in order to suitably support said lip fence.

3. The working table as claimed in claim 2, wherein said shank includes an inner thread formed therein for threading and engaging with said threaded stem.

4. The working table as claimed in claim 2, wherein said threaded stem includes a pad attached to bottom for slidably engaging with said rear guide rail.

5. The working table as claimed in claim 4, wherein said rear guide rail includes a vertical flap secured to said table member, and a horizontal flap extended from said vertical flap, and said pad is slidably engaged with said horizontal flap of said rear guide rail.

6. The working table as claimed in claim 2, wherein said bar includes a channel formed in said rear portion of said bar, and said shank includes a threaded member extended outwardly therefrom and engaged through said channel of said bar for guiding said shank to slide along said channel of said bar and for adjusting said shank relative to said rear portion of said bar and said rear guide rail.

7. The working table as claimed in claim 6, wherein said bar includes an anchor having a screw hole formed therein for threading and engaging with said threaded member of said shank and for securing said shank to said rear portion of said bar.

8. The working table as claimed in claim 7, wherein said anchor includes a protrusion extended therefrom and slidably engaged with said channel of said bar for guiding said shank and said anchor to slide along said channel of said bar.

9. The working table as claimed in claim 7, wherein said shank includes a retaining ring attached to said threaded member for engaging with said anchor and for preventing said anchor from being disengaged from said threaded member of said shank.

10. The working table as claimed in claim 6, wherein said threaded member includes an outer diameter smaller than that of said shank for forming a peripheral shoulder between said threaded member and said shank and for engaging with said bar.

11. The working table as claimed in claim 2, wherein said threaded stem includes a lock nut attached and engaged with said threaded stem for engaging with said shank and for securing said threaded stem to said shank.

12. The working table as claimed in claim 1, wherein said bar includes a securing device attached to said front portion of said bar for selectively securing said bar of said lip fence to said front guide rail.

13. The working table as claimed in claim 1, wherein said lip fence includes at least one auxiliary panel selectively attached to said bar.

14. The working table as claimed in claim 13, wherein said bar includes at least one key hole formed therein, and said at least one auxiliary panel includes at least one key hole formed therein and aligned with said at least one key hole of said bar for receiving a fastener which selectively and detachably secures said at least one auxiliary panel to said bar.

15. The working table as claimed in claim 14, wherein said bar includes at least one opening formed therein for tool receiving purposes.

16. The working table as claimed in claim 15, wherein said bar includes at least one plug for selectively blocking said at least one opening of said bar.
